(19) United States
(12) Patent Application Publication
(10) Pub. No.: US 2011/0253808 A1
(43) Pub. Date: Oct. 20, 2011

(54) PRESSURE SWIRL ATOMIZER WITH REDUCED VOLUME SWIRL CHAMBER

(76) Inventor: Daniel William Bamber, St. Clair Shores, MI (US)

(21) Appl. No.: 13/087,758

(22) Filed: Apr. 15, 2011

Related U.S. Application Data
(60) Provisional application No. 61/324,851, filed on Apr. 16, 2010.

(51) Int. Cl. B05B 1/26

(52) U.S. Cl. 239/518

(57) ABSTRACT

A pressure swirl atomizer includes a swirl chamber having an exit orifice, a first section with a first volume, and a second section with a second volume. The second volume is smaller than the first volume, and the exit orifice disposed in the second section. The atomizer also includes a pintle movable to open and close the exit orifice and a plurality of tangential swirl channels disposed about a circumference of the swirl chamber. The reduced volume of the second section reduces the amount of static fluid to be accelerated into a flow pattern, thereby improving spray quality when the exit orifice is initially opened.

### CROSS-REFERENCE TO RELATED APPLICATIONS

This application claims the benefit of U.S. Provisional application Ser. No. 61/324,851 filed Apr. 16, 2010 entitled REDUCED VOLUME SWIRL CHAMBER FOR A PRESSURE SWIRL ATOMIZER, the entire disclosure of which is hereby incorporated by reference herein.

### TECHNICAL FIELD

The present invention relates to pressure swirl atomizers, and more particularly to a pressure swirl atomizer having a geometry that provides improved spray quality.

### BACKGROUND OF THE INVENTION

Pressure swirl atomizers are used in various applications, including fuel injection systems and exhaust aftertreatment systems. Atomizers disperse fluid into a fine spray by directing fluid from tangential swirl channels into a swirl chamber and then opening a central exit orifice to allow the fluid to exit in a spray pattern. More particularly, the tangential swirl channels cause fluid entering the swirl chamber to swirl in a circular motion and increase its angular velocity as it moves toward the exit orifice. The centrifugal force generated by the swirling motion generates a low pressure zone along the central axis of the swirl chamber.

When the exit orifice is opened, exhaust gas enters the atomizer through the exit orifice and forms an air core through the exit orifice. The fluid forms a “wall” around the air core. Aerodynamic forces break the fluid wall into droplets after it exits the injector. The thickness of this fluid wall and the dimensions of the air core depend on the fluid supply pressure and on the ratio of the diameter of the swirl chamber and the diameter of the exit orifice, and these dimensions in turn control the characteristics of the spray pattern as fluid leaves the exit orifice.

A solenoid-controlled pintle opens and closes the exit orifice to allow or block fluid flow out of the atomizer. When the pintle is closed, the fluid drains through a return flow path. However, since the swirl chamber is designed for optimal flow profiles from the swirl channels to the exit orifice, closing the pintle interrupts this flow profile and creates a “dead” volume of static fluid within the swirl chamber where the fluid is essentially motionless. When the pintle moves back to the open position, the static fluid eventually accelerates to resume its swirling flow pattern, but some of the static fluid still escapes the exit orifice before the flow pattern is completely formed. This results in a pulse of large, poorly distributed drops when the exit orifice initially opens.

In many applications, this negative spray quality is not a concern because the pintle remains continuously open. However, in applications where a variable flow rate is desired, the exit orifice is opened and closed via pulse width modulation (PWM) of the pintle between the open and closed positions. The repeated opening and closing of the exit orifice creates more opportunities for dead volumes of fluid to accumulate and be released the next time the exit orifice is opened. As a result, currently known atomizers do not provide optimal spray quality for applications that vary the flow rate through PWM control.

There is a desire for a pressure swirl atomizer that provides consistent spray quality even when used in applications where the exit orifice is opened and closed during operation.

### SUMMARY OF THE INVENTION

A pressure swirl atomizer according to one embodiment of the invention includes a swirl chamber having an exit orifice, a first section with a first volume, and a second section with a second volume. The second volume is smaller than the first volume, and the exit orifice disposed in the second section. The atomizer also includes a pintle movable to open and close the exit orifice and a plurality of tangential swirl channels disposed about a circumference of the swirl chamber.

The invention is also directed to a solenoid-controlled atomizer system containing a pressure swirl atomizer.

### BRIEF DESCRIPTION OF THE DRAWINGS

FIG. 1 is a cross-sectional view of a pressure swirl atomizer according to one embodiment of the invention;

FIG. 2 is a plan view of an underside of a nozzle used in the pressure swirl atomizer of FIG. 1; and

FIG. 3 is a cross-sectional view of a portion of the pressure swirl atomizer circled as “3” in FIG. 1 according to one embodiment of the invention.

### DETAILED DESCRIPTION OF THE INVENTION

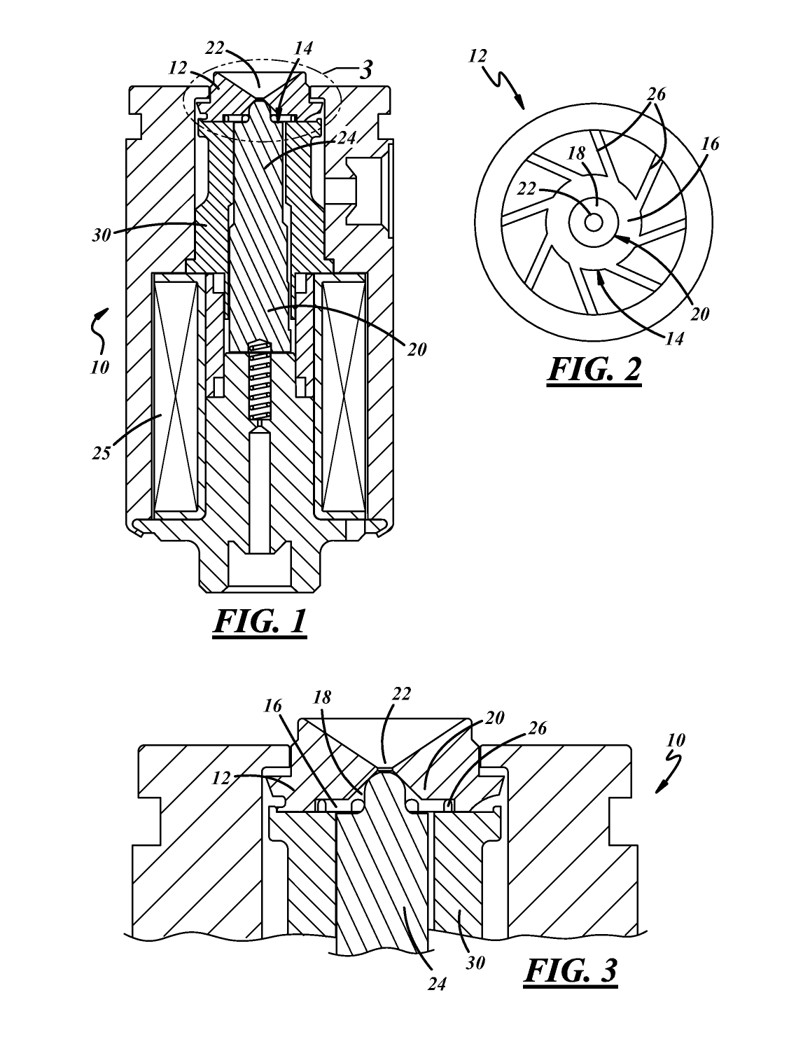

FIGS. 1 and 3 illustrate a pressure swirl atomizer 10 according to one embodiment of the invention, and FIG. 2 illustrates a nozzle 12 used to direct fluid flow in such an atomizer 10. The atomizer 10 according to one embodiment of the invention replaces the conventional conical swirl chamber geometry with a swirl chamber 14 having two sections: a first, larger volume section 16 and a second, smaller volume section 18. A transition 20 where the first and second sections 16, 18 meet may have a sharp change in the angle of the swirl chamber 14, which may act as a pressure choke point.

An exit orifice 22 may be disposed at the center of the swirl chamber 14. The exit orifice 22 may be opened and closed by a pintle 24 that is moveable between an open and a closed position. In one embodiment, the atomizer 10 is operated by a solenoid 25 that controls the position of the pintle 24. The solenoid 25 may energize and de-energize via pulse width modulation (PWM) to open and close the exit orifice 22 and thereby vary the flow rate of the atomizer 10. The solenoid 25 may be designed to provide a quick response at low duty cycles so that the pintle 24 can be moved quickly between the open and closed positions.

As shown in FIG. 2, a plurality of tangential swirl channels 26 are arranged tangentially to the perimeter of the swirl chamber 14 and direct fluid to the swirl chamber 14. A perimeter of the central swirl chamber 14, as defined by the contact points between the swirl channels 26 and the swirl chamber 14, forms a circle having a first diameter. The exit orifice 22 has a second diameter. The ratio between the first and second diameters controls the spray pattern of the atomizer 10 by controlling the size of an air core formed by the swirling fluid, the wall thickness of the swirling fluid itself, and the angular momentum of the fluid. As the fluid moves closer to the center of the swirl chamber 14, the angular velocity of the fluid increases.

When the exit orifice 22 is closed by the pintle 24, excess fluid may drain from the swirl chamber 14 down a return flow path 28 between the pintle 24 and a pintle bearing 30 that houses the pintle 24. In one embodiment, the pintle bearing 30 is a flux collector, but the pintle bearing 30 may be any other component that guides the pintle 24. The drained fluid may be circulated to cool the atomizer 10 and other nearby components, such as the solenoid 25. Note that the return flow path 28 may be disposed elsewhere, such as outside the pintle bearing 30.

In one embodiment, the first section 16 of the central swirl chamber 14 is cylindrical and the second section 18 is conical. However, the first section 16 may also be conical, but with walls at a different angle (e.g., a shallower angle) than in the second section 18, without departing from the scope of the invention. As noted above, the transition 20 between the first and second sections 16, 18 acts as a pressure choke point, allowing static fluid to gather in the first section 16 without interfering with the flow profile of the fluid in the second section 18.

Since only the fluid in the second section 18 is accelerated to generate a spray, the smaller volume of the second section 18 reduces the amount of static liquid that needs to be accelerated, allowing an optimal flow profile to be obtained more quickly. The two-section geometry of the swirl chamber 14 may also reduce the total volume of the swirl chamber 14, further reducing the amount of static liquid.

The diameter of the larger end of the conical second section 18 may be smaller than diameter formed by the inner edges of the swirl channels 26. The geometry allows the proper ratio between the two diameters to ensure high spray quality while at the same keeping the overall volume of the swirl chamber 14 low.

By reducing the volume of static liquid to be accelerated by flow through the swirl channels, the inventive device can generate an optimal flow pattern, and therefore a high-quality spray pattern, as soon as the exit orifice 22 is opened. This allows the inventive pressure swirl atomizer 10 to be used in PWM applications with no reduction of spray quality.

While the best modes for carrying out the invention have been described in detail, those familiar with the art to which this invention relates will recognize various alternative designs and embodiments for practicing the invention within the scope of the appended claims.

What is claimed is:

1. A nozzle for a pressure swirl atomizer, comprising:
a swirl chamber having an exit orifice, a first section with a first volume, and a second section with a second volume, wherein the second volume is smaller than the first volume, and wherein the exit orifice is disposed in the second section; and
a plurality of tangential swirl channels disposed about a perimeter of the swirl chamber.

2. The nozzle of claim 1, wherein the second section is conical.

3. The nozzle of claim 1, wherein the first section is cylindrical.

4. The nozzle of claim 1, wherein the first and second sections are conical, and wherein the first section has a different angle than the second section.

5. The nozzle of claim 1, wherein a transition between the first and second volumes acts as a pressure choke point.

6. The nozzle of claim 1, wherein the second section has a first diameter and the perimeter of the swirl chamber forms a second diameter, and wherein the first diameter is smaller than the second diameter.

7. A pressure swirl atomizer, comprising:
a solenoid;
a pressure swirl atomizer controlled by the solenoid, the pressure swirl atomizer including:
a swirl chamber having an exit orifice, a first section with a first volume, and a second section with a second volume, wherein the second volume is smaller than the first volume, and wherein the exit orifice is disposed in the second section;
a pintle movable to open and close the exit orifice, wherein a position of the pintle is controlled by energization and de-energization of the solenoid; and
a plurality of tangential swirl channels disposed about a circumference of the swirl chamber; and
a pintle bearing that houses the pintle.

8. The pressure swirl atomizer of claim 7, wherein the solenoid controls the position of the pintle via pulse width modulation.

9. The pressure swirl atomizer of claim 7, wherein the second section is conical.

10. The pressure swirl atomizer of claim 7, wherein the first section is cylindrical.

11. The pressure swirl atomizer of claim 7, wherein the first and second sections are conical, and wherein the first section has a different angle than the second section.

12. The pressure swirl atomizer of claim 7, further comprising a return flow path coupled to the swirl chamber.

13. The pressure swirl atomizer of claim 12, wherein the return flow path directs fluid to the solenoid.

14. The pressure swirl atomizer of claim 12, wherein the return flow path is disposed between the pintle and pintle bearing.

15. The pressure swirl atomizer of claim 7, wherein the pintle bearing is a flux collector.
